(19) United States
(12) Patent Application Publication
(10) Pub. No.: US 2025/0264049 A1
(43) Pub. Date: Aug. 21, 2025

(54) METHOD FOR DETECTING EXHAUST BACKFLOW IN AN INTERNAL COMBUSTION ENGINE

(71) Applicant: BRP-ROTAX GMBH & CO. KG, Gunskirchen (AT)

(72) Inventors: Matthias HOFMAIR, Buchkirchen (AT); Michael FORTIER, Sherbrooke (CA)

(21) Appl. No.: 19/056,875

(22) Filed: Feb. 19, 2025

Related U.S. Application Data
(60) Provisional application No. 63/555,158, filed on Feb. 19, 2024.

(51) Int. Cl. F01N 11/00

(52) U.S. Cl. CPC F01N 11/002; F01N 2900/1406

(57) ABSTRACT

A method for detecting exhaust backflow in an air intake plenum of an internal combustion engine (ICE) is disclosed. The method includes: a) determining a maximum gas pressure in the air intake plenum after an opening of an intake valve of the ICE while the intake valve is open; b) determining a reference pressure; c) comparing, by a control unit, the maximum gas pressure to the reference pressure; and d) concluding, by the control unit, a presence of exhaust backflow in the air intake plenum in response to the maximum gas pressure being greater than the reference pressure. A vehicle having a control unit is also disclosed. The control unit has a processor and a memory. The memory stores computer-readable instructions which, when executed, cause the processor to perform the method.

CROSS-REFERENCE

The present application claims priority to U.S. Provisional Patent Application No. 63/555,158, filed Feb. 19, 2024, the entirety of which is incorporated herein by reference.

### TECHNICAL FIELD

The present technology relates to methods for detecting exhaust backflow in internal combustion engines.

### BACKGROUND

Many jurisdictions require that off-road vehicles having internal combustion engines (ICEs) and that are to operate over forest-covered land, grass-covered land or brush-covered land be provided with a spark arrestor in their exhaust system. The spark arrestor helps prevent sparks from exiting the exhaust system which could set fire to the forest, grass, and/or brush.

To be effective, the spark arrestor is typically provided at or near the outlet of the exhaust system. However, this can lead to the spark arrestor becoming clogged by mud and dirt when the off-road vehicle operates in muddy and dirty conditions. As would be understood, this restricts the flow of exhaust gases out of the exhaust system. This results in an increase in exhaust back pressure, which can lead to engine knock and cause other issues with the ICE. A similar increase in exhaust back pressure could happen as a result of damage to one or more components of the exhaust system, such as a muffler or a catalytic converter.

As such, it would be desirable to determine if the spark arrestor gets clogged and/or a component of the exhaust system is damaged in order to prevent these issues from happening. One solution consists in using a knock sensor to sense engine knock. Another solution consists in using an exhaust pressure sensor for sensing exhaust gas pressure in the exhaust system. However, both of these solutions rely on sensors that many ICEs and exhaust systems are not provided with. As such, adding these sensors increases the cost of the vehicle and require programming the ICE's control unit to account for this additional data input.

There is therefore a desire to determine if the spark arrestor gets clogged and/or a component of the exhaust system is damaged without relying on a knock sensor or an exhaust pressure sensor.

### SUMMARY

It is an object of the present technology to ameliorate at least some of the inconveniences present in the prior art.

Typically, when the spark arrestor provided in an exhaust system is not clogged, the gas pressure in an air intake plenum of the internal combustion engine (ICE) drops dramatically when an intake valve of the ICE opens. This is due to the piston moving down in the cylinder of the ICE which sucks the air from the plenum into the combustion chamber of the ICE. It has been found that when the spark arrestor gets clogged, the increase in exhaust back pressure in the exhaust system can lead to exhaust gas flowing back into the air intake plenum when the intake valve opens. A similar increase in exhaust back pressure has been observed as a result of damage to components of the exhaust system that cause the flow of exhaust gases out of the exhaust system to be restricted. The exhaust backflow leads to a momentary increase in gas pressure in the air intake plenum when the intake valve opens, instead of the expected drop in gas pressure. As such, a pressure sensor provided in the air intake plenum, which most vehicles are already provided with, can be used to determine this increase in gas pressure when the intake valve opens and conclude the presence of exhaust backflow. This exhaust backflow is indicative of a clogged spark arrestor or of a damaged exhaust system component. It is contemplated that detecting the presence of exhaust backflow in this manner may also be useful in determining other issues with the ICE or the exhaust system.

According to one aspect of the present technology, there is provided a method for detecting exhaust backflow in an air intake plenum of an ICE. The method comprises: a) determining a maximum gas pressure in the air intake plenum after an opening of an intake valve of the ICE while the intake valve is open; b) determining a reference pressure; c) comparing, by a control unit, the maximum gas pressure to the reference pressure; and d) concluding, by the control unit, a presence of exhaust backflow in the air intake plenum in response to the maximum gas pressure being greater than the reference pressure.

In some embodiments, determining the maximum gas pressure comprises sensing gas pressure in the air intake plenum with a pressure sensor.

In some embodiments, comparing the maximum gas pressure to the reference pressure comprises determining a ratio of the maximum gas pressure over the reference pressure.

In some embodiments, concluding the presence of exhaust backflow comprises concluding the presence of exhaust backflow in response to the ratio being greater than 1.02.

In some embodiments, the maximum gas pressure is a first maximum gas pressure; the reference pressure is a second maximum gas pressure; and the second maximum gas pressure is a maximum pressure of a pressure oscillation in the air intake plenum prior to the opening of the intake valve while the intake valve is closed.

In some embodiments, the reference pressure is an average gas pressure in the air intake plenum over a predetermined range prior to the opening of the intake valve while the intake valve is closed.

In some embodiments, the predetermined range is between a first crank angle and second crank angle. The first crank angle is 180 degrees of crank angle or less before the opening of the intake valve. The second crank angle is a crank angle at the opening of the intake valve.

In some embodiments, the reference pressure is an ambient air pressure; and determining the reference pressure comprises sensing the ambient air pressure with an ambient air pressure sensor disposed outside of the air intake plenum.

In some embodiments, the method also comprises: prior to step a), determining an engine speed; and performing steps a), b), c) and d) only in response to the engine speed being greater than a predetermined engine speed.

In some embodiments, the method also comprises: prior to step a), determining an air charge of a cylinder of the ICE provided with the air intake valve; and performing steps a), b), c) and d) only in response to the air charge being greater than a predetermined air charge.

In some embodiments, the method further comprises: prior to step a), determining a position of a throttle valve disposed upstream of the air intake plenum; and performing steps a), b), c) and d) only in response to the position of the throttle valve being greater than a predetermined position of the throttle valve.

In some embodiments, the method further comprises storing a fault code in a memory in response to concluding the presence of exhaust backflow.

In some embodiments, the method further comprises sensing gas pressure in the air intake plenum over a full engine cycle prior to step a).

In some embodiments, the method further comprises providing a visual indication on a display of a vehicle powered by the ICE in response to concluding the presence of exhaust backflow.

In some embodiments, the method further comprises limiting a torque of the ICE in response to concluding the presence of exhaust backflow.

In some embodiments, the method further comprises retarding an ignition angle of the ICE in response to concluding the presence of exhaust backflow.

In some embodiments, the method further comprises operating the ICE in a limp home mode in response to concluding the presence of exhaust backflow.

According to another aspect of the present technology, there is provided a vehicle having: an internal combustion engine (ICE) defining at least one cylinder; an exhaust system selectively fluidly connected to the at least one cylinder; at least one exhaust valve selectively fluidly connecting the at least one cylinder to the exhaust system; an air intake plenum selectively fluidly connected to the at least one cylinder; at least one intake valve selectively fluidly connecting the air intake plenum to the at least one cylinder; a pressure sensor connected to the air intake plenum configured for sensing gas pressure in the air intake plenum; and a control unit comprising a processor and a memory. The processor is communicatively coupled to the pressure sensor for receiving a signal representative of gas pressure in the air intake plenum. The memory stores computer-readable instructions which, when executed, cause the processor to perform the above method.

In some embodiments, the at least one cylinder is a single cylinder.

In some embodiments, the exhaust system comprises a spark arrestor; and concluding the presence of exhaust backflow is indicative of the spark arrestor being clogged.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

For purposes of the present application, terms related to spatial orientation when referring to a vehicle and components in relation to the vehicle, such as “vertical”, “horizontal”, “forwardly”, “rearwardly”, “left”, “right”, “above” and “below”, are as they would be understood by a driver of the vehicle sitting thereon in an upright driving position, with the vehicle steered straight-ahead and being at rest on flat, level ground.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a right-side elevation view of an all-terrain vehicle (ATV);

FIG. 2 is a top plan view of an internal combustion engine (ICE) and of an exhaust system of the ATV of FIG. 1;

FIG. 3 is a right side elevation of the ICE of FIG. 2;

FIG. 4 is a longitudinal cross-section of the ICE of FIG. 3;

FIG. 5 is a perspective view, taken from a bottom, rear, left side, of a cylinder head and associated components of the ICE of FIG. 3;

FIG. 6 is a top view of a muffler of the exhaust system of FIG. 2, with a body of the muffler being illustrated as see-through such that internal components of the muffler are visible;

FIG. 7 is a schematic illustration of various components of the ATV;

FIG. 8 is a flow-chart of a method for detecting exhaust backflow in an air intake plenum of the ICE of FIG. 3; and

FIG. 9 is a graph of gas pressure profiles in the air intake plenum of the ICE of FIG. 3, with one gas pressure profile illustrating gas pressure during regular operation and one gas pressure profile illustrating gas pressure when a spark arrestor of the muffler of FIG. 6 is clogged.

### DETAILED DESCRIPTION

The present disclosure is not limited in its application to the details of construction and the arrangement of components set forth in the following description or illustrated in the drawings. The disclosure is capable of other embodiments and of being practiced or of being carried out in numerous ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items.

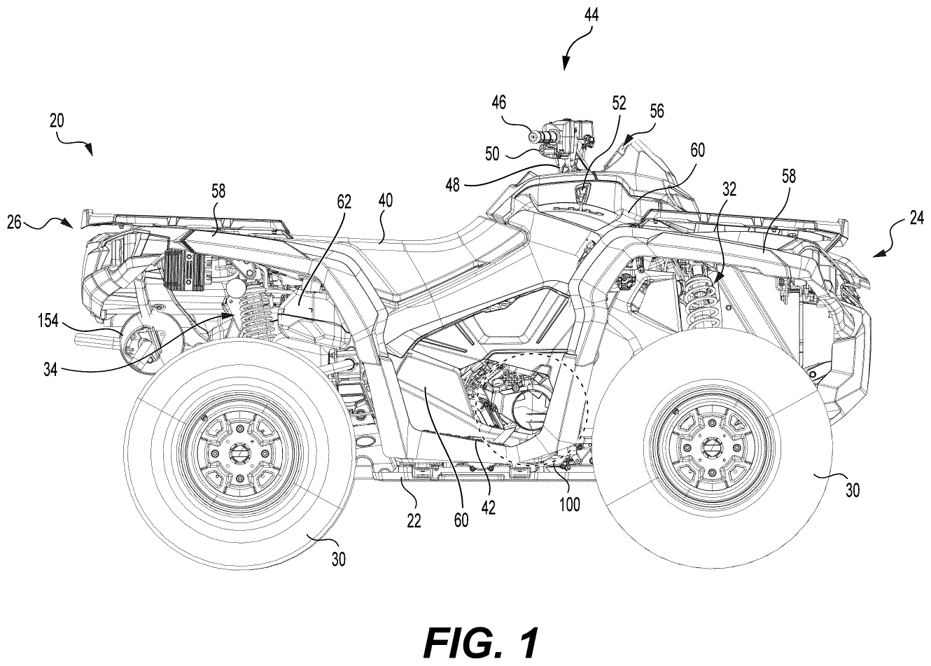

The present technology will be described with reference to a four-wheeled straddle-seat all-terrain vehicle 20 (hereinafter “ATV”) shown in FIG. 1. It is contemplated that the present technology could be applied to other vehicles, such as, but not limited to, off-road side-by-side vehicles (SSVs) and motorcycles, and to other applications using an ICE where the detection of exhaust backflow may be useful.

Referring to FIG. 1, the ATV 20 has a frame 22 having a front end 24 and a rear end 26 defined consistently with a forward travel direction of the ATV 20. The ATV 20 has two front wheels 30 and two rear wheels 30. Each of the four wheels 30 is provided with low-pressure balloon tires adapted for off-road conditions and traversing rugged terrain. It is contemplated that the ATV 20 could have six or more wheels 30 or only three wheels 30. The two front wheels 30 are suspended from the frame 22 by left and right front suspension assemblies 32. The two rear wheels 30 are suspended from the frame 22 by left and right rear suspension assemblies 34.

A straddle seat 40 is connected to the frame 22 for accommodating a driver of the ATV 20. Footrests 42 are provided on either side of the straddle seat 40 and are disposed vertically lower than the straddle seat 40 to support the driver's feet. The footrests 42 are connected to the frame 22. A steering assembly 44 is rotationally mounted to the frame 22 and is operatively connected to the two front wheels 32 to steer the ATV 20. The steering assembly 44 includes a handlebar 46 connected to a steering column assembly 48, that is connected to steering linkages (not shown) operatively connected to left and right front wheels 30.

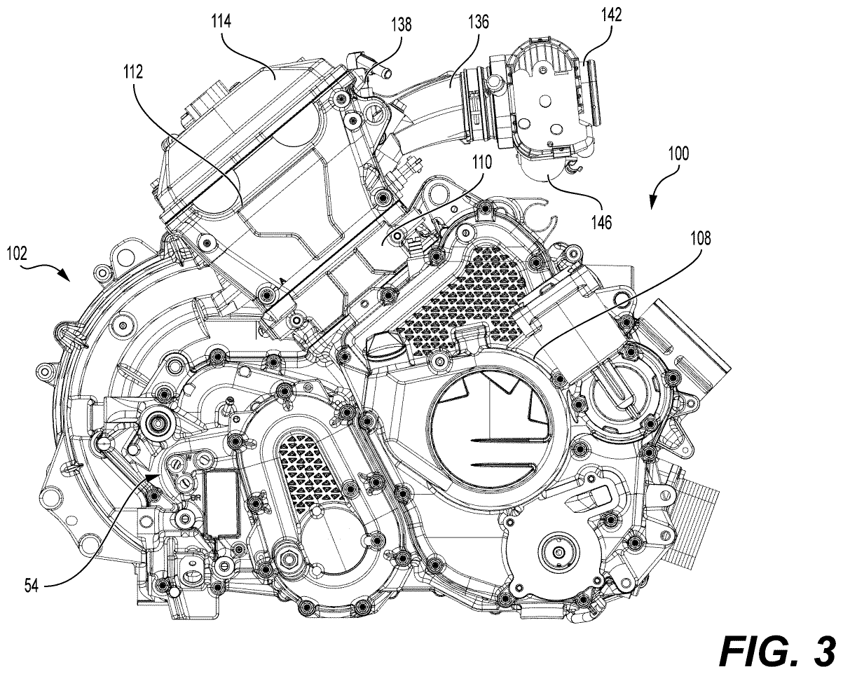

A throttle operator 50, in the form of a thumb-actuated throttle lever, is mounted to the handlebar 46. Other types of throttle operators, such as a finger-actuated throttle lever and a twist grip, are also contemplated. A gear shifter 52 located near the handlebar 46 operates a sub-transmission 54 (FIG. 3) and enables the driver to select one of a plurality of gear configurations for operation of the ATV 20. In the present embodiment, the gear configurations include park, neutral, reverse, low, and high. It is contemplated that the sequence and/or number of gear configurations could be different than as shown herein. A driving mode selector button (not shown) also enables the driver to select 2×4 or 4×4 operation of the ATV 20. A display 56, including a number of gauges, indicator lights and buttons, is disposed forwardly of the handlebar 46. It is contemplated that the display 56 may be or may include one or more screens, which may or may not be touchscreens.

Fenders 58 are disposed over the wheels 30 to protect the driver and/or passenger from dirt, water and other debris being projected by the rotating wheels 30. The fenders 58 also define a portion of the wheel well in which each one of the wheels 30 rotates and, in the case of the front wheels 30, steers. Fairings 60 extend over the frame 22 of the ATV 20 to protect certain components of the ATV 20.

A fuel tank 62 is supported by the frame 22. The fuel tank 88 is disposed below the straddle seat 40 near a rear of the ATV 20. It is contemplated that the fuel tank 62 could be disposed elsewhere in other embodiments.

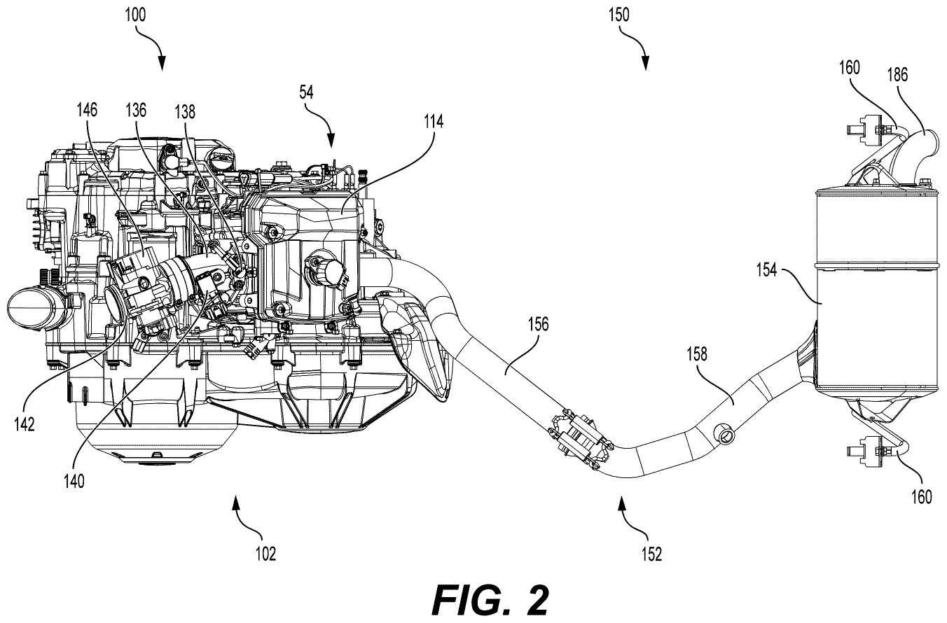

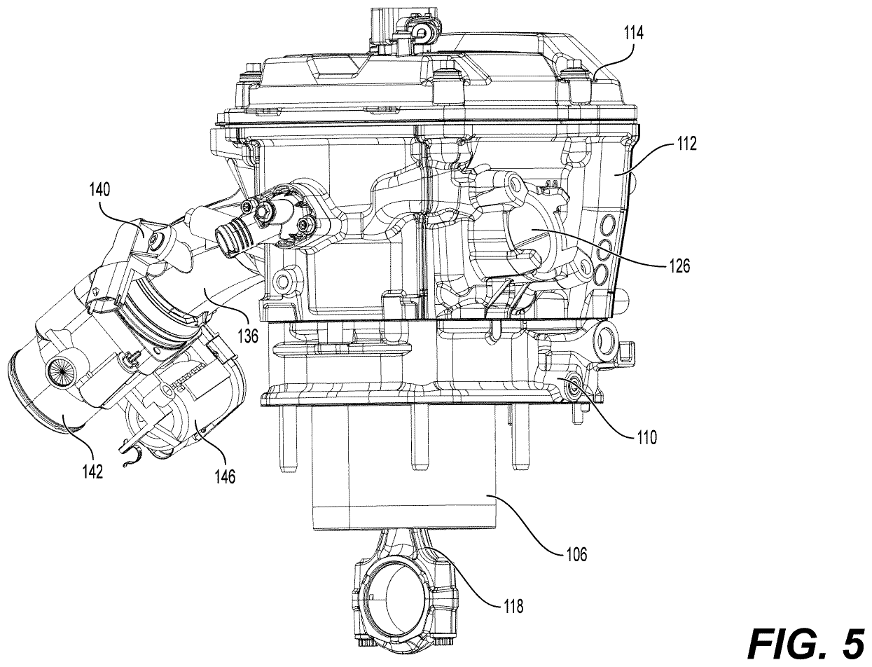

An internal combustion engine 100 (hereinafter “ICE”, schematically illustrated in FIG. 1, but shown in detail in FIGS. 2 to 5) is connected to the frame 22 for powering the ATV 20. The ICE 100 is disposed under the straddle seat 40. The wheels 30 are operatively connected to the ICE 100 via a continuously variable transmission 102 (FIG. 2, hereinafter “CVT”), the sub-transmission 54 and a driveline (not shown). The ICE 100 drives the CVT 102 which drives the sub-transmission 54. The sub-transmission 54 drives the driveline which drives two or four of the wheels 30 depending on whether 2×4 or 4×4 operation is selected. The fuel tank 62 is rearward of the ICE 100.

The ATV 20 further includes other components such as brakes, a radiator, headlights, and the like. As it is believed that these components would be readily recognized by one of ordinary skill in the art, further explanation and description of these components will not be provided herein.

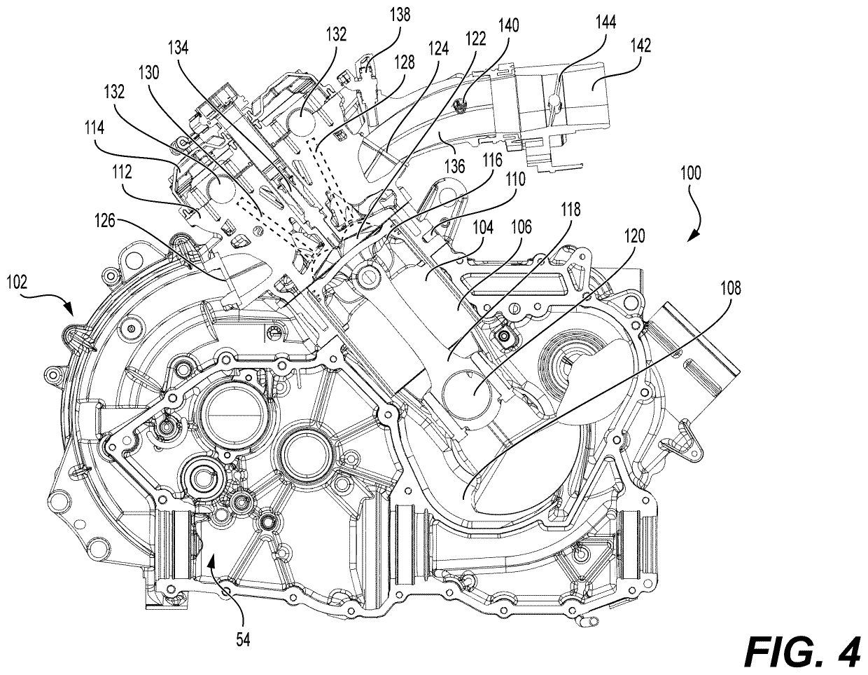

Referring now to FIGS. 3 to 5, the ICE 100 will be described in more details. The ICE 100 is a mono-cylinder, four stroke, internal combustion engine. The ICE 100 thus has a single cylinder 104 (FIG. 4). The cylinder 104 is defined by a cylinder liner 106. The ICE 100 is connected to the frame 22 and is disposed such that the cylinder 104 is inclined towards the rear end 26 of the frame 22. It is contemplated that in some embodiments, the ICE 100 could have more than one cylinder 104.

The ICE 100 has a crankcase 108, a cylinder block 110 connected to the crankcase 108, a cylinder head 112 connected to the cylinder block 110, and a cylinder head cover 114 connected to the cylinder head 112. The cylinder liner 106 extends inside the crankcase 108 and the cylinder block 110. A piston 116 is disposed inside the cylinder 104. The piston 116 reciprocates inside the cylinder 104 when the ICE 100 is in operation. The piston 116 is connected by a connecting rod 118 to a crankshaft 120. The crankshaft 120 is rotationally supported inside the crankcase 108. Reciprocation of the piston 116 causes rotation of the crankshaft 120, which then drives the CVT 102. The cylinder 104, the cylinder head 112 and the piston 116 define a combustion chamber 122 therebetween. The combustion chamber 122 has a minimum volume when the piston 116 is closest to the cylinder head 112. This is known as the top dead center (TDC) position of the piston 116. The combustion chamber 122 has a maximum volume when the piston 116 is furthest from the cylinder head 112. This is known as the bottom dead center (BDC) position of the piston 116.

The ICE 100 has an air intake port 124 defined in a front portion of the cylinder head 112. The air intake port 124 faces forward and upward. The ICE 100 has an exhaust port 126 defined in a rear portion of the cylinder head 112. The exhaust port 126 faces rearward and downward. Intake and exhaust valves 128, 130 (schematically shown in FIG. 4) are opened and closed to permit and prevent fluid communication between the combustion chamber 122 and the intake and exhaust ports 124, 126, respectively. The intake and exhaust valves 128, 130 are opened by cams (not shown) mounted to camshafts 132 that are driven by the crankshaft 120. The intake and exhaust valves 128, 130 are closed by springs (not shown). It is contemplated that the ICE 100 could have one or two intake valves 128 and one or two exhaust valves 130. A spark plug 134 is provided in the cylinder head 112 to ignite an air-fuel mixture in the combustion chamber 122.

An air intake plenum 136 is connected to the cylinder head 112 and is fluidly connected to the air intake port 124. The intake valve 128 selectively fluidly connects the air intake plenum 136 with the combustion chamber 122, and therefore with the cylinder 104. A fuel injector 138 is connected to the air intake plenum 136 for injecting fuel in the air intake plenum 136 and the air intake port 124. It is contemplated that in alternative embodiments the fuel injector 138 could be connected to the cylinder head 112 for injecting fuel directly inside the combustion chamber 122. A pressure sensor 140 is connected to the air intake plenum 136 for sensing gas pressure inside the air intake plenum 136 upstream of the fuel injector 138.

A throttle body 142 is connected to the air intake plenum 136 such that during operation of the ICE 100, air flows from the throttle body 142, to the air intake plenum 136, to the air intake port 124 and to the combustion chamber 122. The throttle body 142 has a throttle valve 144 (FIG. 4) that is actuated by an electric motor 146. The position of the throttle valve 144 controls a flow of air to the combustion chamber 122. It is contemplated that in an alternative embodiment the throttle valve 144 could be actuated via a cable connected to the throttle operator 50.

It is contemplated that other components could be fluidly connected to the throttle body 142, upstream of the throttle body 142, such as, but not limited to, an airbox and an air filter.

With reference to FIG. 2, an exhaust system 150 of the ATV 20 will now be described. The exhaust system 150 is fluidly connected to the exhaust port 126. The exhaust valve 130 selectively fluidly connects the exhaust system 150 with the combustion chamber 122, and therefore with the cylinder 104.

The exhaust assembly 150 includes an exhaust pipe 152 and a muffler 154. The exhaust pipe 152 has a forward portion 156 that is connected to cylinder head 112 and is fluidly connected to the exhaust port 76. The exhaust pipe 152 has a rearward portion 158 that is connected to the muffler 154. The muffler 154 is connected to the frame 22, near the rear end 26 of the frame 22, by rods 160. The muffler 154 extends laterally.

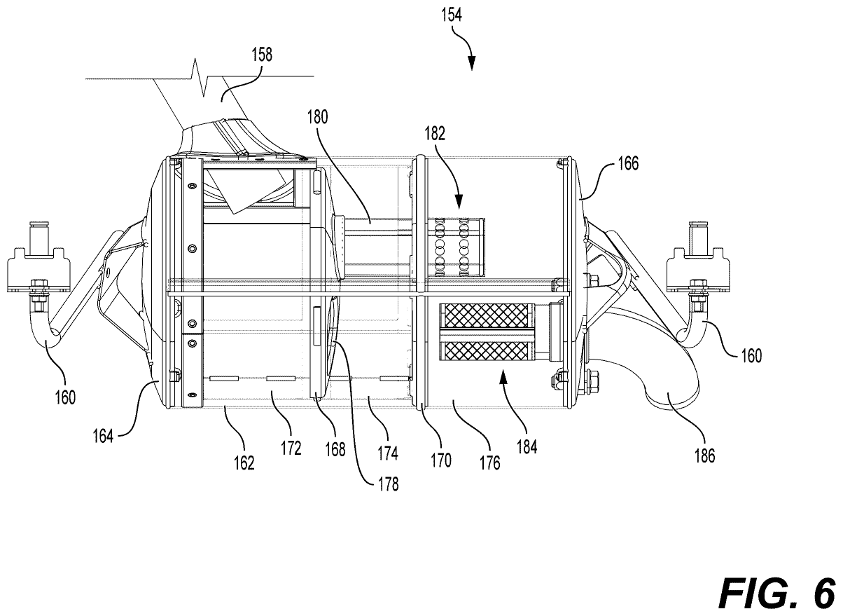

With reference to FIG. 6, the muffler 154 will now be described in more detail. The muffler 154 has a muffler body 162 closed at a left end thereof by a left end cap 164 and at a right end thereof by a right end cap 166. Left and right walls 168, 170 are disposed inside the muffler body 162 to separate the muffler body 162 into three chambers 172, 174, 176. A left chamber 172 is defined laterally between the left end cap 164 and the left wall 168. A middle chamber 174 is defined laterally between the left wall 168 and the right wall 170. A right chamber 176 is defined laterally between the right end cap 166 and the right wall 170. The rearward portion 158 of the exhaust pipe 152 is connected to the muffler body 162 at a front left portion thereof to supply exhaust gas to the left chamber 172. An aperture 178 fluidly communicates the left chamber 172 with the middle chamber 174. A pipe 180 fluidly communicates the left chamber 172 with the right chamber 176. The pipe 180 has apertures 182 along a contour of a right portion thereof that is received inside the right chamber 176. A flame arrestor 184 is disposed inside the right chamber 176. The flame arrestor 184 is offset from the pipe 180. In the present embodiment, the flame arrestor 184 is a metal mesh tube, but other types of flame arrestors are contemplated. The flame arrestor 184 is connected to a tail pipe 186 that extends through the right end cap 166. During regular operation, the flame arrestor 184 permits the passage of exhaust gas from the right chamber 176 to the tail pipe 186 but helps prevent sparks from exiting the tail pipe 186. However, mud and dirt entering the tail pipe 186 from outside the ATV 20 could cause the holes in the mesh of the flame arrestor 184 to become clogged, thereby restricting the passage of exhaust gas from the right chamber 176 to the tail pipe 186 which results in an increase in exhaust back pressure. Should the flame arrestor 184 become significantly clogged, this could lead to engine knock and other issues. It is contemplated that the muffler 154 could have a construction that is different from the one described above. For example, it is contemplated that the muffler 154 could have only one, two or more than three chambers.

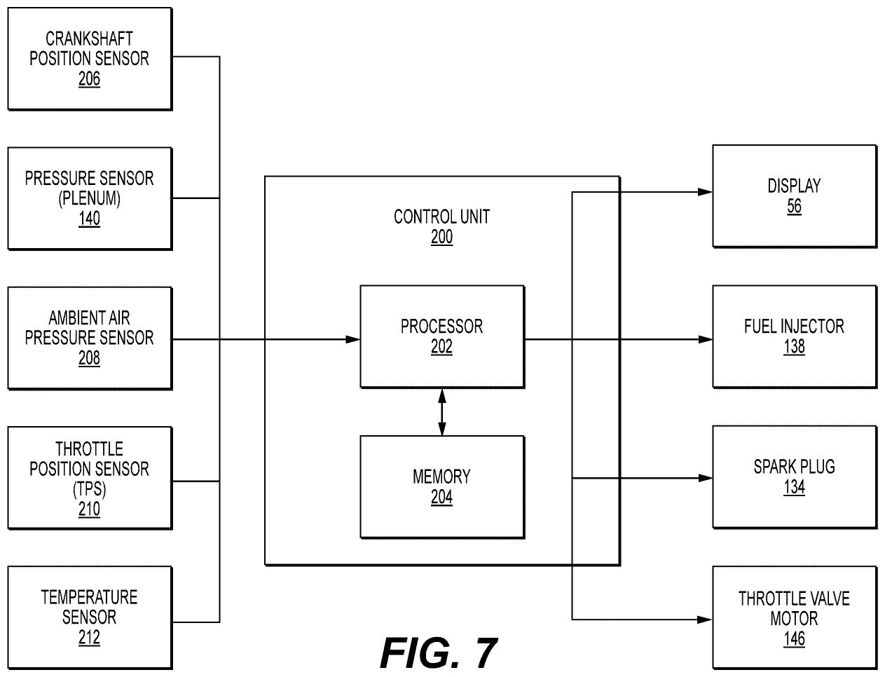

Turning now to FIG. 7, additional components of the ATV 20 will be described. The ATV 20 has a control unit 200 that receives signals from various sensors, some of which are described below, and uses these signals to control operation of various components of the ATV 20, such as the ICE 100. The control unit 200 has a processor 202 and a non-transitory memory 204 that stores the computer-readable instructions in a non-transitory medium (not shown) included in the memory 204. When executed, the computer-readable instructions cause the processor to perform the computer-readable instructions. It is contemplated that the processor 202 could be multiple processors. The processor 202 may be a general-purpose processor or may be a specific-purpose processor comprising one or more preprogrammed hardware or firmware elements (e.g., application-specific integrated circuits (ASICs), electrically erasable programmable read-only memories (EEPROMs), etc.) or other related elements. It is contemplated that the memory 204 could be multiple memories. The non-transitory medium of the memory 204 may be a semiconductor memory (e.g., read-only memory (ROM) and/or random-access memory (RAM)), a magnetic storage medium, an optical storage medium, and/or any other suitable type of memory. While the control unit 200 is represented as being one entity in this embodiment, it is understood that the control unit 200 could include separate entities for controlling components separately.

The previously described pressure sensor 140 is communicatively coupled to the processor 202 for sending a signal representative of gas pressure in the air intake plenum 136 to the processor 202. A crankshaft position sensor 206 senses a position of the crankshaft 120. The position of the crankshaft 120 is expressed as a crank angle. As the ICE 100 is a four-stroke engine, a full combustion cycle of the ICE occurs over two full rotations of the crankshaft 120, the crank angle has a value from 0 to 720 degrees, with the 0 degree position and the 720 degrees position being the same. The crankshaft position sensor 206 senses crank angles over 360 degrees. A signal from an additional sensor, such as a camshaft position sensor, or computational methods are used by the processor 202 to determine if the crankshaft 120 is in the first rotation of the combustion cycle (i.e., 0 degree to 360 degrees) or the second rotation of the combustion cycle (i.e., 360 degrees to 720 degrees). The crankshaft position sensor 206 is communicatively coupled to the processor 202 for sending a signal representative of the position of the crankshaft 120 (i.e., the crank angle) to the processor 202. Based on the change in crank angle over time, the processor 202 can determine an engine speed of the ICE 100. The engine speed corresponds to the speed of rotation of the crankshaft 120 and is expressed in revolutions per minute (RPM). An ambient air pressure sensor 208 senses an ambient air pressure (i.e., the air pressure of the environment in which the ATV 20 operates). The ambient air pressure sensor 208 is communicatively coupled to the processor 202 for sending a signal representative of the ambient air pressure to the processor 202. It is contemplated that the ambient air pressure sensor 208 could be omitted in some embodiments. A throttle position sensor (TPS) 210 senses a degree of opening of the throttle valve 144, referred to herein as throttle position (TP). The TPS 210 is communicatively coupled to the processor 202 for sending a signal representative of the TP to the processor 202. A temperature sensor 212 senses a temperature of one of ambient air temperature, a temperature of the air in the air intake plenum 136 being supplied to the combustion chamber 122, and a temperature of the exhaust gas in the exhaust system 150. The temperature sensor 212 is communicatively coupled to the processor 202 for sending a signal representative of the sensed temperature to the processor 202. It is contemplated that more than one temperature sensor 212 could be provided, each of which would sense a different one of the temperatures mentioned above. It is contemplated that the temperature sensor 212 could be omitted in some embodiments. It is contemplated that the ATV 20 could have additional sensors.

Based on the information provided at least by the above sensors, and using the instructions stored in the memory 204, the processor 202 controls various components of the ATV 20 by sending signals to these components. The processor 202 is communicatively coupled to the display 56 for controlling the information displayed on the display 56, such as vehicle speed, engine speed, fuel level, and various error messages or icons. The processor 202 is communicatively coupled to the fuel injector 138 for controlling an injection timing and a quantity of fuel to be injected. The processor 202 is communicatively coupled to the spark plug 134 for controlling an ignition timing. The processor 202 is communicatively coupled to the throttle valve motor 146 for controlling a position of the throttle valve 144. It contemplated that the processor 202 could be communicatively coupled to other components of the ATV 20 for controlling their operations.

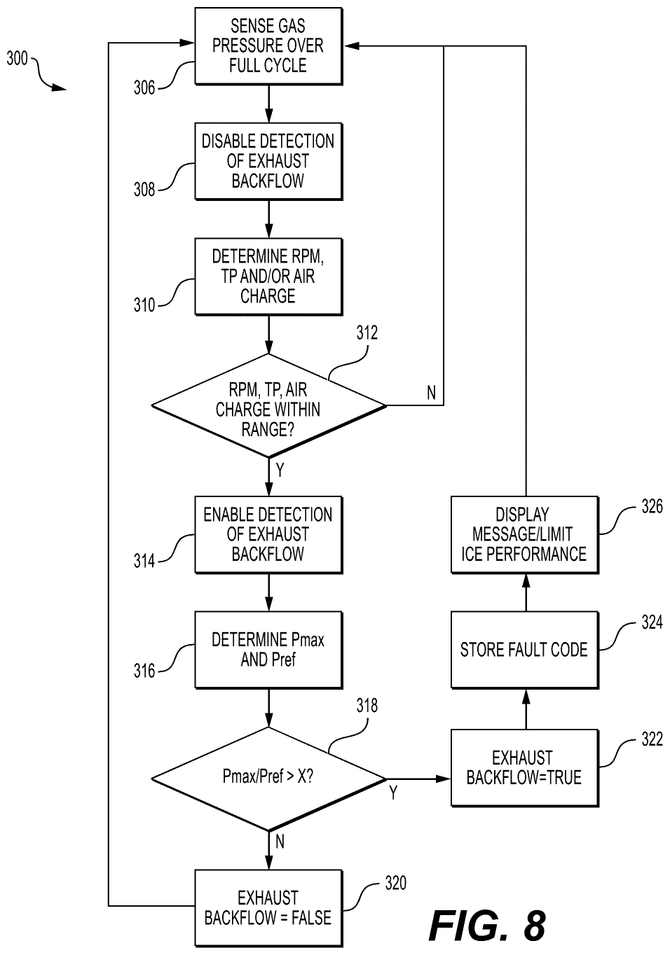

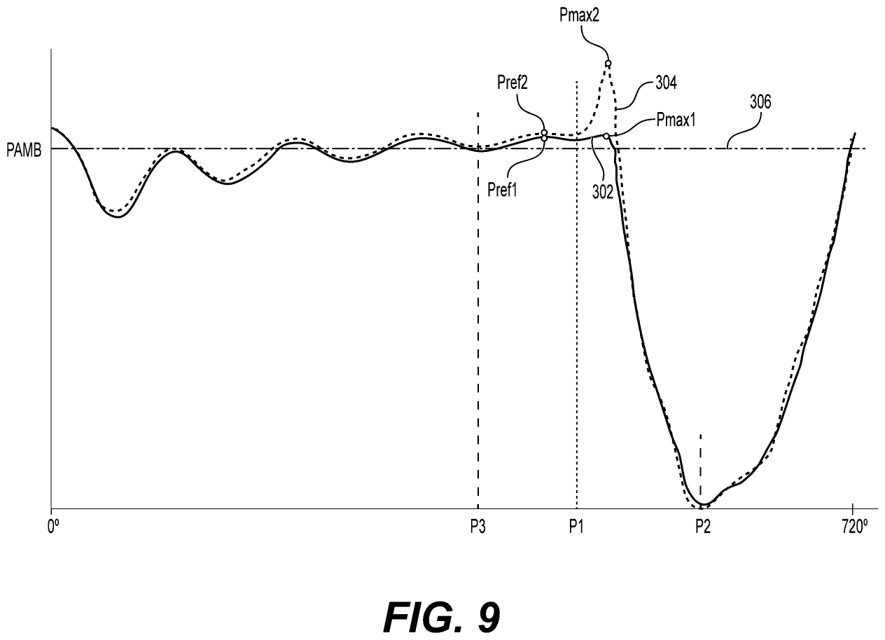

Turning now to FIG. 8, and with reference to FIG. 9, a method 300 for detecting exhaust backflow in the air intake plenum 136 of the ICE 100 will be described. The presence of exhaust backflow in the air intake plenum 136 can be indicative of the spark arrestor 184 being clogged. The presence of exhaust backflow in the air intake plenum 136 can also be indicative of damage to components of the exhaust system 150 that cause the flow of exhaust gases out of the exhaust system 150 to be restricted. The method 300 will be described below for the purpose of indicating if the spark arrestor 184 is clogged. The computer-readable instructions for performing the method 300 are stored in the memory 204 and, when executed, cause the processor 202 to perform the method 300.

FIG. 9 illustrates gas pressure profiles in the air intake plenum 136 as measured by the pressure sensor 140 with the ICE 100 operating at a constant engine speed and at a constant TP. One gas pressure profile, corresponding to the solid line 302, illustrates gas pressure in the air intake plenum 136 during regular operation (i.e., with the spark arrestor 184 being unclogged or minimally clogged). The other gas pressure profile, corresponding to the dashed line 304, illustrates gas pressure in the air intake plenum 136 when the spark arrestor 184 is clogged.

With reference to the solid line 302, during regular operation when the intake valve 128 opens at crank angle P1, the gas pressure inside the air intake plenum 136 drops rapidly until the intake valve 128 closes at crank angle P2. In the present embodiment, the crank angle P2 corresponds to the BDC position of the piston 116. After the intake valve 128 closes, the gas pressure inside the air intake plenum 136 increases rapidly, as shown between crank angle P2 and 720 degrees of crank angle. The gas pressure inside the air intake plenum 136 then oscillates with decaying amplitude that averages near ambient pressure, illustrated by dash-dot line 306, as shown between 0 degree of crank angle and P1. However, with reference to the dashed line 304, with the spark arrestor 184 clogged, when the intake valve 128 opens at crank angle P1, the gas pressure inside the air intake plenum 136 first increases rapidly and then drops rapidly until the intake valve 128 closes at crank angle P2. As can be seen in FIG. 9, the rest of the pressure profile illustrated by the line 304 is similar to the pressure profile illustrated by the line 302.

Turning to FIG. 8, the method 300 begins at step 306 where pressure inside the air intake plenum 136 is sensed by the pressure sensor 140 over a full engine cycle (i.e., 720 degrees). This establishes a baseline pressure profile. Then at step 308, the functions related to the detection of exhaust backflow are disabled. Then at step 310, one or more of engine speed (RPM), throttle position (TP) and air charge are determined by the processor 202 using the corresponding sensors. The air charge is a quantity of air in the combustion chamber 122 when the piston 116 is at BDC. The air charge is based on air temperature, air pressure and throttle position, and can be determined by the processor 202 by a mathematical model and/or lookup tables stored in the memory 204. Then at step 312, the processor 202 determines if the one or more of the engine speed (RPM), throttle position (TP) and air charge determined at step 310 are within a predetermined range. If the values are outside of the predetermined range, the difference in gas pressure inside the air intake plenum 136 after opening the intake valve 128 between an unclogged spark arrestor 184 and a clogged spark arrestor 184 may be too small to detect by the pressure sensor 140. The range will depend on the specific construction of the ICE 100, the air intake plenum 136, and the exhaust system 150 and the sensitivity of the pressure sensor 140. For the engine speed, at step 312 the processor 202 determines if the engine speed is greater that a predetermined engine speed, moves to step 314 if it is, and moves back to step 306 if it is not. For the throttle position, at step 312 the processor 202 determines if the throttle position is greater that a predetermined throttle position, moves to step 314 if it is, and moves back to step 306 if it is not. For the air charge, at step 312 the processor 202 determines if the air charge is greater that a predetermined air charge, moves to step 314 if it is, and moves back to step 306 if it is not. It is contemplated that the processor 202 could additionally check if the engine speed, the throttle position and the air charge are also below an upper threshold. For embodiments where more than one of the engine speed, the throttle position and the air charge are determined at step 310 and compared to a range at step 312, the processor moves to step 314 only if all of them are within their respective ranges, and moves back to step 306 otherwise. At step 314 the functions related to the detection of exhaust backflow are enabled and the processor 202 continues to step 316. It is contemplated that in some embodiments, one or more of steps 306 to 314 could be omitted. It is also contemplated that all of steps 306 to 314 could be omitted and that the method 300 would begin at step 316.

At step 316, the processor 202 determines a maximum gas pressure Pmax in the air intake plenum 136 after the opening of the intake valve 128 while the intake valve 128 is open (i.e., between P1 and P2 in FIG. 9) and determines a reference pressure Pref. The maximum gas pressure Pmax is determined based on the gas pressure sensed by the pressure sensor 140. With reference to FIG. 9, for regular operation (i.e., unclogged spark arrestor 184) this corresponds to point Pmax1 and when exhaust backflow is present (i.e., clogged spark arrestor 184) this corresponds to point Pmax2. The difference between Pmax1 and Pmax2 depends on how clogged the spark arrestor 184, with the difference increasing the more the spark arrestor 184 is clogged. The reference pressure Pref can be determined in different ways, some of which will be described below. In one embodiment, the reference pressure Pref is the ambient air pressure 306 sensed by the ambient air pressure sensor 208. In another embodiment, the reference pressure Pref is an average gas pressure sensed by the pressure sensor 140 in the air intake plenum 136 over a predetermined range prior to the opening of the intake valve 128 at P1 while the intake valve 128 is closed. In some embodiments, the predetermined range corresponds to the one full pressure oscillation prior to the opening of the intake valve 128 at P1. In other embodiments, the predetermined range is between crank angles P3 and P1 in FIGS. 9, and P3 is less than 180 degrees of crank angle before P1. In another embodiment, the reference pressure Pref is the maximum gas pressure of the one full pressure oscillation prior to the opening of the intake valve 128 at P1 while the intake valve 128 is closed. In FIG. 9, this corresponds to Pref1 or Pref2 depending on the pressure profile (i.e., line 302 or 304). It is contemplated that the processor 202 could select the reference pressure Pref differently depending on the situation. For example, the processor 202 could use the ambient air pressure as the reference pressure Pref, but could switch to one of the other two methods of determining the reference pressure Pref should the ambient air pressure sensor 208 fail.

From step 316, the processor 202 moves to step 318. At step 318, the processor 202 compares the maximum gas pressure Pmax determined at step 316 (i.e., Pmax1 or Pmax 2) to the reference pressure Pref. In the present embodiment, this is achieved by calculating a ratio of the maximum gas pressure Pmax over the reference pressure Pref. If this ratio is less than or equal to a predetermined value X, then at step 320 the processor 202 concludes that exhaust backflow is not present in the air intake plenum 136, which is indicative of an unclogged spark arrestor 184, and then returns to step 306. If the ratio calculated at step 318 is greater than the predetermined value X, then at step 320 the processor 202 concludes that exhaust backflow is present in the air intake plenum 136, which is indicative of a clogged spark arrestor 184, and then moves to step 324. In some embodiments, the predetermined value X is 1.02. In other embodiments, the predetermined value is 1.05. Other values of X are contemplated depending on the sensitivity of the pressure sensor 140. In an alternative embodiment, it is contemplated that at step 318, instead of calculating a ratio, the processor 202 could determine if the maximum pressure Pmax is greater than the reference pressure Pref, or if the maximum pressure Pmax is greater than the reference pressure Pref by a predetermined amount. If the maximum pressure Pmax is greater than the reference pressure Pref (or greater by the predetermined amount), the processor 202 moves to step 322, otherwise the processor 202 moves to step 320.

At step 324, a fault code is stored the memory 204 indicative that exhaust backflow is present based on a signal received from the processor 202. Then at step 326 the processor 202 sends a signal to the display 56 to provide a visual indication of the findings of the presence of exhaust backflow. This message could be words such as “clean spark arrestor” or “check spark arrestor”, or an icon representative of a clogged spark arrestor 184. Alternatively, at step 326 the processor 202 could control the ICE 100 in such a way as to limit performance of the ICE 100 to reduce the likelihood of engine knock occurring due to the exhaust backflow caused by the clogged spark arrestor 184. It is contemplated that the processor 202 could both limit performance of the ICE 100 and display a message on the display 56 at step 326. At step 326, performance of the ICE 100 can be achieved by entering a “limp home” operation mode where maximum torque, engine speed and/or engine acceleration are limited, which can be accompanied by the display 56 displaying the words “limp home” or a corresponding icon. Performance of the ICE 100 can be limited by limiting a torque of the ICE 100, by retarding an ignition angle of the ICE 100, by reducing a quantity of fuel injected in the combustion chamber 122, by modifying a timing of the fuel injection, by limiting a maximum opening of the throttle valve 144. It is contemplated that the order of steps 324 and 326 could be reversed. It is also contemplated that steps 324 and 326 could be performed in parallel. It is also contemplated that one of steps 324 and 326 could be omitted. From step 326, the processor 202 goes back to step 306.

Modifications and improvements to the above-described embodiments of the present invention may become apparent to those skilled in the art. The foregoing description is intended to be exemplary rather than limiting. The scope of the present technology is therefore intended to be limited solely by the appended claims.

What is claimed is:

1. A method for detecting exhaust backflow in an air intake plenum of an internal combustion engine (ICE) comprising:
a) determining a maximum gas pressure in the air intake plenum after an opening of an intake valve of the ICE while the intake valve is open;
b) determining a reference pressure;
c) comparing, by a control unit, the maximum gas pressure to the reference pressure; and
d) concluding, by the control unit, a presence of exhaust backflow in the air intake plenum in response to the maximum gas pressure being greater than the reference pressure.

2. The method of claim 1, wherein determining the maximum gas pressure comprises sensing gas pressure in the air intake plenum with a pressure sensor.

3. The method of claim 1, wherein comparing the maximum gas pressure to the reference pressure comprises determining a ratio of the maximum gas pressure over the reference pressure.

4. The method of claim 3, wherein concluding the presence of exhaust backflow comprises concluding the presence of exhaust backflow in response to the ratio being greater than 1.02.

5. The method of claim 1, wherein:
the maximum gas pressure is a first maximum gas pressure;
the reference pressure is a second maximum gas pressure; and
the second maximum gas pressure is a maximum pressure of a pressure oscillation in the air intake plenum prior to the opening of the intake valve while the intake valve is closed.

6. The method of claim 1, wherein the reference pressure is an average gas pressure in the air intake plenum over a predetermined range prior to the opening of the intake valve while the intake valve is closed.

7. The method of claim 6, wherein:
the predetermined range is between a first crank angle and second crank angle;
the first crank angle being 180 degrees of crank angle or less before the opening of the intake valve; and
the second crank angle is a crank angle at the opening of the intake valve.

8. The method of claim 1, wherein:
the reference pressure is an ambient air pressure; and
determining the reference pressure comprises sensing the ambient air pressure with an ambient air pressure sensor disposed outside of the air intake plenum.

9. The method of claim 1, further comprising:
prior to step a), determining an engine speed; and
performing steps a), b), c) and d) only in response to the engine speed being greater than a predetermined engine speed.

10. The method of claim 1, further comprising:
prior to step a), determining an air charge of a cylinder of the ICE provided with the air intake valve; and
performing steps a), b), c) and d) only in response to the air charge being greater than a predetermined air charge.

11. The method of claim 1, further comprising:
prior to step a), determining a position of a throttle valve disposed upstream of the air intake plenum; and
performing steps a), b), c) and d) only in response to the position of the throttle valve being greater than a predetermined position of the throttle valve.

12. The method of claim 1, further comprising storing a fault code in a memory in response to concluding the presence of exhaust backflow.

13. The method of claim 1, further comprising sensing gas pressure in the air intake plenum over a full engine cycle prior to step a).

14. The method of claim 1, further comprising providing a visual indication on a display of a vehicle powered by the ICE in response to concluding the presence of exhaust backflow.

15. The method of claim 1, further comprising limiting a torque of the ICE in response to concluding the presence of exhaust backflow.

16. The method of claim 1, further comprising retarding an ignition angle of the ICE in response to concluding the presence of exhaust backflow.

17. The method of claim 1, further comprising operating the ICE in a limp home mode in response to concluding the presence of exhaust backflow.

18. A vehicle comprising:
an internal combustion engine (ICE) defining at least one cylinder;
an exhaust system selectively fluidly connected to the at least one cylinder;
at least one exhaust valve selectively fluidly connecting the at least one cylinder to the exhaust system;
an air intake plenum selectively fluidly connected to the at least one cylinder;
at least one intake valve selectively fluidly connecting the air intake plenum to the at least one cylinder;
a pressure sensor connected to the air intake plenum configured for sensing gas pressure in the air intake plenum; and
a control unit comprising a processor and a memory, the processor being communicatively coupled to the pressure sensor for receiving a signal representative of gas pressure in the air intake plenum, the memory storing computer-readable instructions which, when executed, cause the processor to perform the method of claim 1.

19. The vehicle of claim 18, wherein the at least one cylinder is a single cylinder.

20. The vehicle of claim 18, wherein:
the exhaust system comprises a spark arrestor; and
concluding the presence of exhaust backflow is indicative of the spark arrestor being clogged.
